(19) United States
(12) Patent Application Publication
(10) Pub. No.: US 2025/0309794 A1
(43) Pub. Date: Oct. 2, 2025

(54) POWER TOOL AND CONTROL METHOD

(71) Applicant: JIANGSU DONGCHENG TOOLS TECHNOLOGY CO., LTD, Nantong (CN)

(72) Inventors: Chunlei LU, Nantong (CN); Yadong CUI, Nantong (CN)

(21) Appl. No.: 18/863,085

(22) PCT Filed: Sep. 28, 2023
(86) PCT No.: PCT/CN2023/122759

§ 371 Date: Nov. 5, 2024

(30) Foreign Application Priority Data
Aug. 30, 2022 (CN) 202211049838.0

(51) Int. Cl. H02P 3/18; B25B 21/00; H02K 11/21; H02K 11/33; H02P 23/24

(52) U.S. Cl. CPC H02P 3/18; B25B 21/00; H02K 11/21; H02K 11/33; H02P 23/24

(57) ABSTRACT

The example discloses a power tool and a control method. The power tool includes a driving unit and a control unit. The control unit connect with a mode selection device, a parameter detection unit, and a speed detection unit, and the mode selection device is provided with at least one gear position of releasing a fastener. If the parameters of the motor operation are continuously smaller than the preset motor parameter within first preset time, the control unit outputs slow braking signals with the duty cycle less than 100% to the driving unit so as to control the motor to be braked slowly and lasts for second preset time, and the control unit receives the motor rotating speed detected by the rotating speed detection unit and controls the motor to be kept at the preset rotating speed.

### TECHNICAL FIELD

The subject matter herein generally relates to power tools controlling.

### BACKGROUND

Current power tools, such as screw batch, impact wrench, etc., have a reverse function. The shutdown operation in the process of reversing fasteners basically relies on the user to loosen the switch independently to cut off the motor current, and the power tools will stop rotating, otherwise the power tools will keep rotating. Because the speed of the tools is usually relatively high, in the process of reversing fasteners, the fastener can be very easily to be rotated and dropped if the switch is not loosened in time. Existing power tools can detect whether the fastener is loosened through a pre-set threshold. When the fastener is detected to be loosened, the power tool will brake and stop rotating automatically, which the user is not required to make a judgment call. However, if the fasteners have different sizes and/or the working conditions are varied, the fastener may be too loose or not loosened enough after the reverse stop of the power tool, and the motor speed is high. In these above described scenarios, it may be difficult for the user to make appropriate determinations.

Please refer to China Invention Patent issued No. CN104795795B published on Jun. 20, 2017, which reveals a power tool. When the motor is reversed, the control device compares the current value collected by the current detection device with the preset current value stored in the control device. If the current value is continuously less than the preset current value for a preset period of time, the motor supply current is turned off. For fasteners of different sizes and working conditions, this control mode may cause the fasteners sometimes too loose or not loose after the reverse shutdown of the power tool, and the motor speed is high, which makes it difficult for user to control the power tool to meet different demand.

In view of this, the present disclosure provides an improved power tool to overcome the shortcomings of the existing technology.

### SUMMARY OF DISCLOSURE

Aiming at the shortcomings of the prior art, the disclosure aims to provide a power tool and a control method that can enable users to control motor shutdown according to the actual situation.

A power tool, comprising a housing, a motor arranged inside the housing, a fastener, a driver unit configured to drive the motor, and a control unit electrically connected with the driver unit. The control unit is electrically connected with a mode selection device, a parameter detection unit configured to detect operation parameters of the motor, and a speed detection unit configured to detect a speed of the motor. The mode selection device comprises at least one gear position of releasing a fastener, the control unit comprises a preset motor parameter and a preset motor speed. At the gear position of releasing the fastener, the parameter detection unit detects the operation parameters of the motor and compares the operation parameters of the motor detected by the parameter detection unit with the preset motor parameter. When the operation parameters of the motor detected by the parameter detection unit are continuously less than the preset motor parameter within the first preset time, the control unit outputs slow braking signals of less than 100% duty cycle to the drive unit to control the motor to brake slowly and continue running up to the second preset time. After the second preset time, the control unit receives the speed of the motor detected by the speed detection unit and controls the motor to maintain at the preset motor speed.

In one embodiment, the preset motor parameter of the motor pre-stored in the control unit comprise an operation current value of the motor or a break-variable of current, the break-variable of current is a current variable quantity of the motor in a process from being installed with a load to the load being removed.

In one embodiment, the driving unit comprises an upper bridge arm and a lower bridge arm, when the driving unit receives the slow braking signals, the lower bridge arm is turned on and the upper bridge arm is turned off.

In one embodiment, the slow braking signals is a fixed duty cycle less than 100% or a variable duty cycle less than 100%.

In one embodiment, at the gear position of releasing the fastener, the control unit comprises a normal speed of the motor reversed, the preset motor speed is greater than zero and less than the normal speed of the motor reversed.

In one embodiment, the control unit comprises a duty cycle corresponding to the preset motor speed, when the speed of the motor is lower than the preset motor speed, the control unit increases the duty cycle of signals outputted to the drive unit, to maintain the motor at the preset motor speed.

In one embodiment, when the speed of the motor is higher than the preset motor speed, the control unit decreases the duty cycle of the signals outputted to the drive unit, to maintain the motor at the preset motor speed.

In one embodiment, when the motor speed is zero and the motor is stopped running, the control unit restarts the motor, and outputs signals with a preset duty cycle to the drive unit, to maintain the motor at the preset motor speed.

In one embodiment, the control unit is further electrically connected with a positive-negative rotation switch, at the gear position of releasing the fastener, the control unit controls the motor to reverse after detecting signals from the positive-negative rotation switch.

A control method applied to a power tool. The control method comprises: select the release fastener gear, at the gear position of releasing the fastener, the parameter detection unit detects the operation parameters of the motor and compares the motor parameters detected by the parameter detection unit with the preset motor parameter. When the operation parameters of the motor detected by the parameter detection unit are continuously less than the preset motor parameter within the first preset time, the control unit outputs slow braking signals of less than 100% duty cycle to the drive unit to control the motor to slow brake and continue running up to the second preset time. After the second preset time, the control unit receives the speed of the motor detected by the speed detection unit and controls the motor to maintain at the preset motor speed.

The preset motor parameter and preset motor speed of the motor are stored advance through the control unit in advance. At the gear position of releasing the fastener, the parameter detection unit detects the parameters of the motor operation and compares the motor parameters detected by the parameter detection unit with the preset parameters. If the motor parameters detected by the parameter detection unit are continuously less than the preset motor parameter within the first preset time, the control unit outputs slow braking signals of less than 100% duty cycle to the drive unit to control the motor to brake slowly and continue running up to the second preset time. The control unit receives the motor speed detected by the speed detection unit, and controls the motor to maintain the preset motor speed, thus the user can control the motor to stop according to the actual situation.

### BRIEF DESCRIPTION OF THE DRAWINGS

Implementations of the present technology will now be described, by way of example only, with reference to the attached figures.

FIG. 1 is an structure diagram of a power tool according to one embodiment of the present application.

FIG. 2 is an embodiment of a circuit diagram of the power tool shown in FIG. 1.

FIG. 3 is a structure diagram of an embodiment of a mode select device of the power tool shown in FIG. 1.

FIG. 4 is a current graph of the power tool shown in FIG. 1.

The meaning of the mark in the figure:
Power tool 100; Housing 1;
Output head 2; Body part 3;
Grip part 4; Foot plate part 5;
Master switch 6; Battery pack 7;
Drive unit 8; Control unit 9;
Mode select device 10; Parameter detection unit 11;
Speed detection unit 12; Upper bridge arm 81;
Lower bridge arm 82; Low speed gear 101
Medium speed gear 102; High speed gear 103;
Release fastener gear 104; Display unit 105;
Positive-negative rotation switch 13.

### DETAILED DESCRIPTION

The invention is further explained in detail in combination with the attached drawings and embodiments.

The terms used in the invention are only for the purpose of describing specific embodiments and are not intended to limit the invention. For example, the words “up”, “down”, “front”, “back”, etc. indicating the orientation or position relationship are based solely on the orientation or position relationship shown in the attached figure. Only to facilitate the description of the invention and simplify the description, and not to indicate or imply that the device/element referred to must have a particular orientation or be constructed and operated in a particular orientation, is not to be construed as a limitation of the present invention.

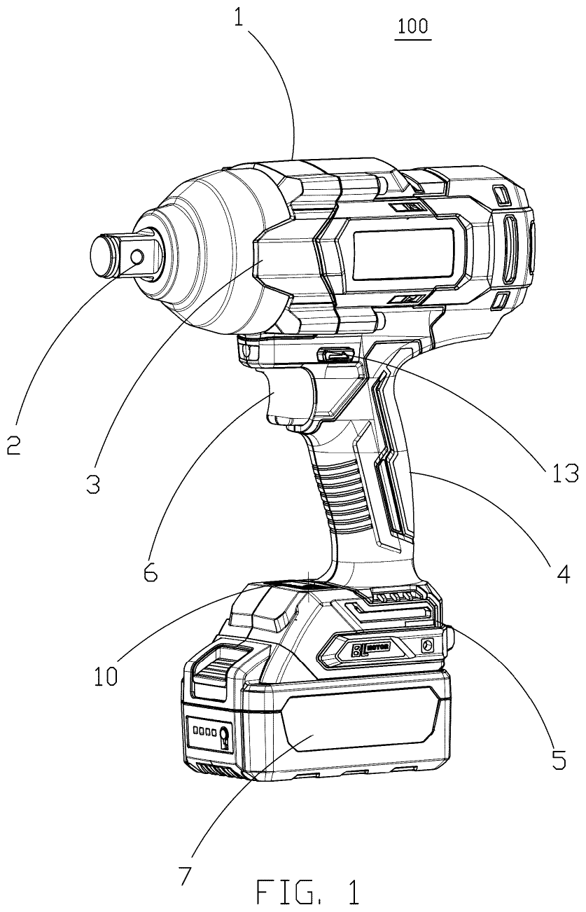

Referring to FIG. 1, the power tool 100 is configured to plug a working head (not shown). In one embodiment, the power tool 100 is an electric wrench, which includes a housing 1, a motor 14 located in the housing 1, and an output head 2 driven by the motor. The output head 2 is partially exposed at a front end of the housing 1 and connected to the working head. The housing 1 includes a body part 3 extending axially, a grip part 4 connected below the body part 3, and a foot plate part 5 located at the lower end of the grip part 4. The motor 14 and the output head 2 are accommodated in the body part 3, and the output head 2 part is exposed at the front end of the body part 3. The grip part 4 is configured to be held when operated by the user, and a master switch 6 is arranged in the grip part 4. The master switch 6 can be a trigger, a button, etc. The master switch 6 is configured to be operated by the user to control a start or a stop of the power tool 100. In one embodiment, the master switch 6 is a trigger. The foot plate part 5 may be configured to receive the battery pack 7 and deliver power supplied by the received battery pack 7 to the respective components of the power tool 100.

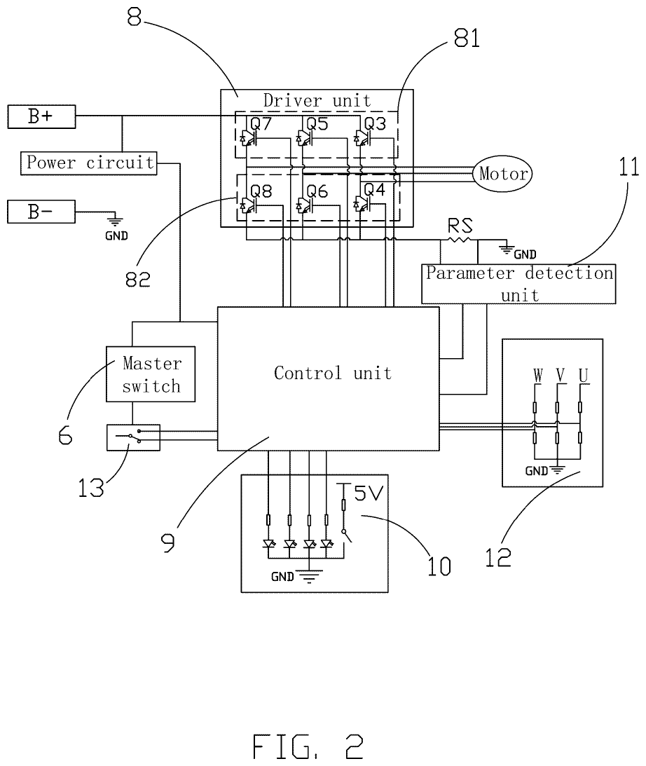

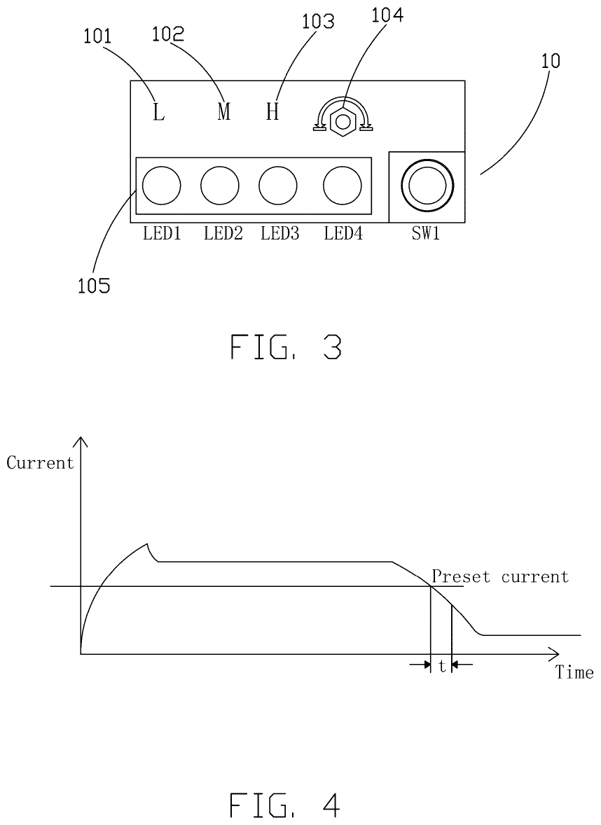

Referring to FIG. 2 and FIG. 3, the housing 1 further includes a drive unit 8 to drive the motor and a control unit 9 electrically connected with the drive unit 8. The control unit 9 is connected with a mode selection device 10, a parameter detection unit 11 detecting the motor parameters, and a speed detection unit 12 detecting the motor speed. The mode select device 10 includes at least one gear position 104 of releasing the fastener configured to release the fastener. The control unit 9 includes a preset motor parameter, a preset motor speed, a first preset time, and a second preset time, the preset motor parameter, the preset motor speed, the first preset time, and the second preset time are configured to release the fastener. The preset parameters do not include the preset motor speed. At the gear position 104 of releasing the fastener, the parameter detection unit 11 detects the operation parameters of the motor 14 and compares the motor parameters detected by the parameter detection unit 11 with the preset motor parameter. If the motor parameters detected by the parameter detection unit 11 are continuously less than the preset parameters within the first preset time t, the control unit 9 outputs slow braking signals of less than 100% duty cycle, to the drive unit 8 to control the motor to brake slowly and continue running up to the second preset time. After the second preset time, the control unit 9 receives the motor speed detected by the speed detection unit 12 and controls the motor to maintain at the preset motor speed. The first preset time t and the second preset time are stored in the control unit 9.

In one embodiment, the drive unit 8 includes an upper bridge arm 81 and a lower bridge arm 82. The upper bridge arm 81 includes switch tubes of Q3, Q5, and Q7, and the lower bridge arm 82 includes switch tubes of Q4, Q6, and Q8. When the drive unit 8 receives the slow braking signals, the switch tubes of Q3, Q5, and Q7 of the upper bridge arm 81 are turned off, and the switch tubes of Q4, Q6, and Q8 of the lower bridge arm 82 are turned on. The preset motor parameter stored in advance by the control unit 9 is the preset current value of the motor operation, and the duty cycle corresponding to the preset motor speed is also stored in the control unit 9. The parameter detection unit 11 is a current detection unit, and the current detection unit 11 detects the current value or the break-variable of current when the motor 14 is running. The break-variable of current is a current variable quantity of the motor in a process from being installed with a load to the load being removed.

As shown in FIGS. 2, 3, the mode selection device 10 includes four working gears and a display unit 105. The four working gears includes a low speed gear 101, a medium speed gear 102, a high speed gear 103, and a release fastener gear 104, and the display unit 105 includes four LED lights. The user can switch between the four working gears by pressing the mode selection switch SW1 of the mode selection device 10, and the selected working gears can be displayed through the LED lights of the display unit 105. The low speed gear 101, the medium speed gear 102, and the high speed gear 103 are the gears of the positive rotation mode. If the user selects the low speed gear 101, the LED1 lamp corresponding to the low speed gear 101 is illuminated. If the user selects the medium speed gear 102, the LED2 lamp corresponding to the medium speed gear 102 is illuminated. If the user selects the high speed gear 103, the LED3 lamp corresponding to the high speed gear 103 is illuminated. If the user selects the release fastener gear 104, the LED4 lamp corresponding to the release fastener gear 104 is illuminated. Under the low speed gear 101 or the medium speed gear 102 or the high speed gear 103, the user triggers the master switch 6, the control unit 9 receives the closing signals from the master switch 6, controlling the drive unit 8 to drive the motor 14 to work, and the control unit 9 adjusts the speed of the motor 14 by adjusting the duty cycle of the output.

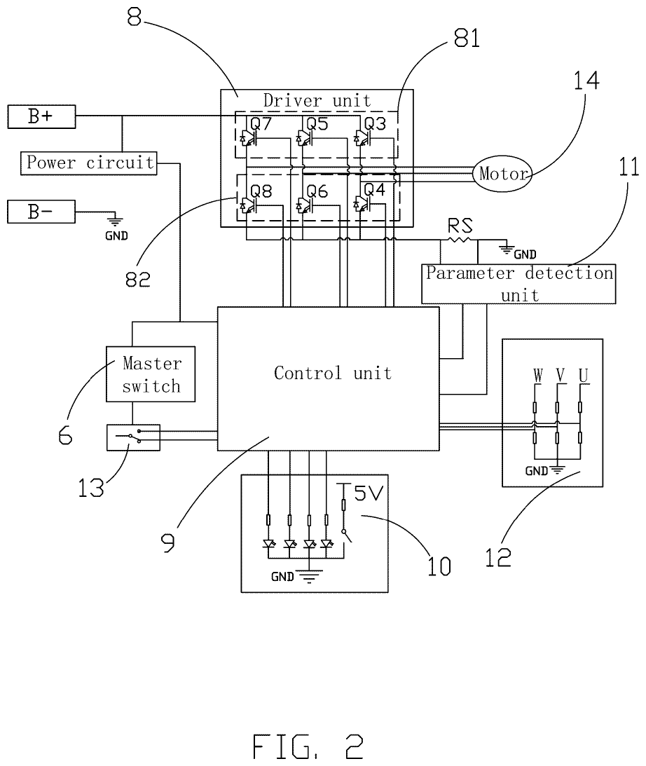

Referring to FIG. 2, FIG. 3, and FIG. 4, in one embodiment, the control unit 9 is further connected with a positive-negative rotation switch 13. After the user triggers the master switch 6, the control unit 9 controls the drive unit 8 to drive the motor 14 when receiving the closing signals from the master switch 6. Under the low speed gear 101 or the medium speed gear 102 or the high speed gear 103, if the positive-negative rotation switch 13 is in the positive rotation position, the motor 14 is running positively, and the control unit 9 adjusts the speed of the motor 14 by adjusting the duty cycle of signals outputted. At the gear position 104 of releasing the fastener, if the positive-negative rotation switch 13 is in the reverse position, the motor 14 runs inversely, and the current detection unit 11 detects the running current of the motor, and compares the current detected by the current detection unit 11 with the preset current value. If the current detected by the current detection unit 11 is continuously less than the preset current value within the first preset time t, the control unit 9 controls the motor to brake slowly.

When the power tool 100 performs slow braking, the control unit 9 outputs slow braking signals of less than 100% duty cycle, and when the drive unit 8 receives the slow braking signal, the motor is controlled to perform slow braking within the second preset time. The slow braking signals either have a fixed duty cycle less than 100% or a variable duty cycle less than 100%. In one embodiment, the fixed duty cycle of less than 100% is a fixed duty cycle of 50%, and the control unit 9 controls the drive unit 8 to drive the motor 14 with a fixed duty cycle of 50% to slowly brake until the speed of the motor 14 is reduced to the preset motor speed. The duty cycle with a change of less than 100% is a step duty cycle with a gradual increase of 10% duty cycle, and the control unit 9 controls the drive unit 8 to drive the motor 14 with the signals of step changed duty cycle to slowly brake until the speed of the motor 14 is reduced to the preset motor speed. The normal speed of the motor reversed is also stored in the control unit 9, and the preset motor speed is greater than zero and less than the normal speed of the motor reversed. In one embodiment, the preset motor speed is the lowest speed at which the motor can operate.

After the control unit 9 controlling the motor to slowly brake, if the motor speed is lower than the preset motor speed, the control unit 9 increases the duty ratio outputting to the drive unit 8 to control the motor 14 to maintain the preset motor speed. If the motor speed is higher than the preset motor speed, the control unit 9 reduces the duty cycle of signals outputting to the drive unit 8 to control the motor 14 to maintain the preset motor speed. If the motor speed is zero or less than the preset motor speed after slowly braking, that is, the motor speed is less than the minimum speed at which the motor 14 can operate normally or the motor has stopped running, the control unit 9 controls the motor 14 to restart and outputs signals with a preset duty cycle to the drive unit 8 to control the motor 14 to maintain the preset motor speed. Through slowly braking, the speed of the motor 14 can be rapidly reduced and maintained at a very low preset motor speed. As for fasteners with different sizes and different working conditions, the user can control the time when the motor 14 stops according to the actual situation.

The power tool stores the preset motor parameter and preset motor speed of the motor 14 in advance through the control unit 9. At the gear position 104 of releasing the fastener, the parameter detection unit 11 detects the parameters of the motor operation, and compares the motor parameters detected by the parameter detection unit 11 with the preset parameters. If the motor parameters detected by the parameter detection unit 11 are continuously less than the preset parameters within the first preset time, the control unit 9 outputs slow braking signals of less than 100% duty cycle to the drive unit 8 to control the motor 14 to brake slowly and continue running up to the second preset time. The control unit 9 receives the motor speed detected by the speed detection unit 12, and controls the motor 14 to maintain the preset motor speed, thus the user can control the motor 14 to stop according to the actual situation.

The invention is not limited to the above specific embodiments. It can be easily understand that there are many other alternatives to the electric tools and control methods of the invention without deviating from the principle and scope of the invention. The scope of protection of the invention is subject to the contents of the claims.

1. A power tool comprising a housing, a motor arranged inside the housing, a driver unit configured to drive the motor, and a control unit electrically connected with the driver unit.
wherein the control unit is electrically connected with a mode selection device, a parameter detection unit configured to detect operation parameters of the motor, and a speed detection unit configured to detect a speed of the motor, the mode selection device comprises at least one gear position of releasing a fastener, the control unit comprises a preset motor parameter, a preset motor speed, a first preset time, and a second preset time, wherein the first preset time and the second preset time are set based on a time of releasing the fastener; the preset motor parameter, the preset motor speed, the first preset time, and the second preset time are configured to release the fastener,
at the gear position of releasing the fastener, the parameter detection unit detects the operation parameters of the motor and compares the operation parameters of the motor detected by the parameter detection unit with the preset motor parameter, when the operation parameters of the motor detected by the parameter detection unit are continuously less than the preset motor parameter within the first preset time, the control unit outputs slow braking signals of less than 100% duty cycle to the drive unit to control the motor to brake slowly and continue running up to the second preset time, after the second preset time, the control unit receives the speed of the motor detected by the speed detection unit and controls the motor to maintain at the preset motor speed.

2. The power tool of claim 1, wherein the preset motor parameter pre-stored in the control unit comprise an operation current value of the motor or a break-variable of current, the break-variable of current is a current variable quantity of the motor in a process from being installed with a load to the load being removed.

3. The power tool of claim 1, wherein the driving unit comprises an upper bridge arm and a lower bridge arm, when the driving unit receives the slow braking signals, the lower bridge arm is turned on and the upper bridge arm is turned off.

4. The power tool of claim 3, wherein the slow braking signals is a fixed duty cycle less than 100% or a variable duty cycle less than 100%.

5. The power tool of claim 1, wherein at the gear position of releasing the fastener, the control unit comprises a normal speed of the motor reversed, the preset motor speed is greater than zero and less than the normal speed of the motor reversed.

6. The power tool of claim 1, wherein the control unit comprises a duty cycle corresponding to the preset motor speed, when the speed of the motor is lower than the preset motor speed, the control unit increases the duty cycle of signals outputted to the drive unit, to maintain the motor at the preset motor speed.

7. The power tool of claim 6, wherein when the speed of the motor is higher than the preset motor speed, the control unit decreases the duty cycle of the signals outputted to the drive unit, to maintain the motor at the preset motor speed.

8. The power tool of claim 6, wherein when the motor speed is zero and the motor is stopped running, the control unit restarts the motor, and outputs signals with a preset duty cycle to the drive unit, to maintain the motor at the preset motor speed.

9. The power tool of claim 6, wherein the control unit is further electrically connected with a positive-negative rotation switch, at the gear position of releasing the fastener, the control unit controls the motor to reverse after detecting signals from the positive-negative rotation switch.

10. A control method applied to a power tool, wherein the power tool comprises a housing, a motor accommodated in the housing, a driver unit configured to drive the motor, and a control unit electrically connected with the driver unit, the control unit is connected with a mode selection device, a parameter detection unit configured to detect the motor parameters, and a speed detection unit configured to detect the motor speed, the mode selection device has at least one gear position of releasing a fastener, the control unit comprises a preset motor parameter, a preset motor speed, a first preset time, and a second preset time, the preset motor parameter, wherein the first preset time and the second preset time are set based on a time of releasing the fastener; the preset motor speed, the first preset time, and the second preset time are configured to release the fastener, the control method comprises:
selecting the gear position of releasing a fastener, at the gear position of releasing the fastener, the parameter detection unit detects the operation parameters of the motor and compares the motor parameters detected by the parameter detection unit with the preset motor parameter, when the operation parameters of the motor detected by the parameter detection unit are continuously less than the preset motor parameter within the first preset time, the control unit outputs slow braking signals of less than 100% duty cycle to the drive unit to control the motor to slow brake and continue running up to the second preset time, after the second preset time, the control unit receives the speed of the motor detected by the speed detection unit and controls the motor to maintain at the preset motor speed.

11. The power tool of claim 3, wherein the upper bridge arm comprises a first switch tube, a second switch tube, and a third switch tube, the lower bridge arm comprises a fourth switch tube, a fifth switch tube, and a sixth switch tube, when the driving unit receives the slow braking signal, the first switching tube, the second switching tube, and the third switching tube are turned off, and the fourth switching tube, the fifth switching tube, and the sixth switching tube are turned on.

12. The control method of claim 11, wherein the preset motor parameter of the motor pre-stored in the control unit comprise an operation current value of the motor or a break-variable of current, the break-variable of current is a current variable quantity of the motor in a process from being installed with a load to the load being removed.

13. The control method of claim 11, wherein the driving unit comprises an upper bridge arm and a lower bridge arm, when the driving unit receives the slow braking signals, the lower bridge arm is turned on and the upper bridge arm is turned off.

14. The control method of claim 13, wherein the upper bridge arm comprises a first switch tube, a second switch tube, and a third switch tube, the lower bridge arm comprises a fourth switch tube, a fifth switch tube, and a sixth switch tube, when the driving unit receives the slow braking signal, the first switching tube, the second switching tube, and the third switching tube are turned off, and the fourth switching tube, the fifth switching tube, and the sixth switching tube are turned on.

15. The control method of claim 13, wherein the slow braking signals is a fixed duty cycle less than 100% or a variable duty cycle less than 100%.

16. The control method of claim 11, wherein at the gear position of releasing the fastener, the control unit further comprises a normal speed of the motor reversed, the preset motor speed is greater than zero and less than the normal speed of the motor reversed.

17. The control method of claim 11, wherein the control unit comprises a duty cycle corresponding to the preset motor speed, when the speed of the motor is lower than the preset motor speed, the control unit increases the duty cycle of signals outputted to the drive unit, to maintain the motor at the preset motor speed.

18. The control method of claim 17, wherein when the speed of the motor is higher than the preset motor speed, the control unit decreases the duty cycle of the signals outputted to the drive unit, to maintain the motor at the preset motor speed.

19. The control method of claim 17, wherein when the motor speed is zero and the motor is stopped running, the control unit restarts the motor, and outputs signals with a preset duty cycle to the drive unit, to maintain the motor at the preset motor speed.

20. The control method of claim 17, wherein the control unit is further electrically connected with a positive-negative rotation switch, at the gear position of releasing the fastener, the control unit controls the motor to reverse after detecting signals from the positive-negative rotation switch.
